(19) United States
(12) Patent Application Publication
(10) Pub. No.: US 2015/0284251 A1
(43) Pub. Date: Oct. 8, 2015

(54) Carbon Product

(71) Applicant: Johnson Electric S.A., Murten (CH)

(72) Inventors: Jing Chao ZHENG, Hong Kong (CN); Yiu Chung WU, Hong Kong (CN); Chi Man LAW, Hong Kong (CN); Xiu Xian WANG, Shenzhen (CN)

(21) Appl. No.: 14/677,306

(22) Filed: Apr. 2, 2015

(30) Foreign Application Priority Data
Apr. 2, 2014 (CN) 201410132393.1

(51) Int. Cl. C01B 31/00; H01R 43/06; H02K 13/00; H01R 39/04; C01B 31/02; H02K 13/04

(52) U.S. Cl. CPC C01B 31/00; C01B 31/02; H02K 13/04; H02K 13/006; H01R 39/045; H01R 43/06; C01P 2006/10; C01P 2006/40

(57) ABSTRACT

A carbon product is made of mesocarbon microbeads and graphite. Preferably, the weight percent of mesocarbon microbeads is 50-99% and the weight percent of graphite is 1-50%. Preferably, when the graphite is carbon-graphite, the carbon product has a density in the range of 1.6-1.8 g/cm³ and a resistivity in the range of 2000-8000 μΩ·cm. Preferably, when the graphite is electro-graphite, the carbon product has a density in the range of 1.85-1.95 g/cm³ and a resistivity in the range of 500-2000 μΩ·cm. The carbon product may be a carbon brush, a carbon bearing, a carbon seal or a brush contact member for a commutator of an electric motor.

### CROSS REFERENCE TO RELATED APPLICATIONS

This non-provisional patent application claims priority under 35 U.S.C. §119(a) from Patent Application No. 201410132393.1 filed in The People's Republic of China on Apr. 2, 2015, the entire contents of which are hereby incorporated by reference.

### FIELD OF THE INVENTION

This invention relates to a method of making a carbon product and to the carbon product, especially a commutator having carbon segments, for a permanent magnet, direct current (PMDC) motor.

### BACKGROUND OF THE INVENTION

Existing products, available in the marketplace, including carbon brushes, graphite discs and carbon bearings, are made from electrographite (EG), carbon-graphite (CG) and resin-bonded graphite (RG) materials.

EG materials are carbographitic materials that are graphitized at temperatures in excess of 2500° C., in order to transform basic amorphous carbon into artificial graphite. The raw materials include petroleum coke, carbon black, coal coke and pitch as a binder.

CG materials are made from a mixture of coke and graphite powders, agglomerated with pitch or resin. This powder is molded into blocks, which are baked at a temperature of about 1000° C. to convert the binder into coke. These grades are not graphitized. The raw materials include natural/artificial graphite, petroleum coke, carbon black, coal coke, and pitch/phenolic resin as a binder.

RG materials are powdered natural or artificial graphite mixed with a thermo-setting resin. The mixture is then pressed and polymerized at a suitable curing temperature of about 200° C. The raw materials include natural/artificial graphite, petroleum coke, carbon black, coal coke, with pitch/phenolic or epoxy resin as the binder.

The main problem with existing EG, CG and RG products is required long and complicated processing steps which increases the material and fabrication costs. Another problem with existing EG, CG and RG products is low strength and short lifetime.

Thus, there exists a need for a carbon product which has simplified processing steps. In addition, there exists a need for a carbon product with improved strength.

### SUMMARY OF THE INVENTION

Accordingly, in one aspect thereof, the present invention provides a carbon product made of mesocarbon microbeads and graphite, wherein the weight percent of mesocarbon microbeads is 50-99% and the weight percent of graphite is 1-50%.

Preferably, the weight percent of mesocarbon microbeads is 70-80% and the weight percent of graphite is 20-30%.

Preferably, the carbon product has a density in the range of 1.6-1.8 g/cm³ and a resistivity in the range of 2000-8000 μΩ·cm. This is particularly suitable for products where the graphite is CG.

Alternatively, the carbon product has a density in the range of 1.85-1.95 g/cm³ and a resistivity in the range of 500-2000 μΩ·cm. This is particularly suitable for products where the graphite is EG.

Preferably, the carbon product is a carbon brush, a carbon bearing, a carbon seal or a brush contact surface.

According to a second aspect, the present invention provides a commutator for an electric motor, comprising: a base made of insulation material; an electrically conductive member fixed to the base, the electrically conductive member comprising a plurality of bars each with a tang for connection of a lead wire of the motor; and a contact member forming a brush contact surface, the contact member comprising a plurality of segments each electrically connected with a corresponding bar, the contact member comprising mesocarbon microbeads and graphite.

Preferably, in the contact member the weight percent of mesocarbon microbeads is greater than 1% but less than 100% and the weight percent of graphite is less than 99%.

Preferably, in the contact member the weight percent of mesocarbon microbeads is 50-99% and the weight percent of graphite is 1-50%.

Preferably, in the contact member the weight percent of mesocarbon microbeads is 70-80% and the weight percent of graphite is 20-30%.

Preferably, the graphite is natural graphite or artificial graphite.

Preferably, the diameter of the mesocarbon microbeads is less than 150 μm.

According to a third aspect, the present invention provides a method of making a carbon product, comprising: mixing mesocarbon microbeads and electrographite; iso-static pressing the mixed mesocarbon microbeads and electrographite to form a blank; sintering the blank; graphitizing the sintered blank; and machining the graphitized blank to form a predetermined shape of the carbon product.

Preferably, the method includes sieving the mesocarbon microbeads to choose mesocarbon microbeads with size less than predetermined size before the mixing step.

According to a further aspect, the present invention provides a method of making a carbon product, comprising the steps of: mixing together powdered mesocarbon microbeads and powdered carbon-graphite; kneading the mixed mesocarbon microbead and graphite powder; compressing the mixed powder to form a blank; sintering the blank; and machining the sintered blank to form the carbon product.

Preferably, the powder is sieved after the kneading step and before the compressing step.

Preferably, the powder is mixed after the sieving step and before the compressing step.

Preferably, the blank is sintered such that the density of the sintered blank is in the range of 1.6-1.8 g/cm³ and the resistivity of the sintered blank is in the range of 2000-8000 μΩ·cm.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates an exemplary commutator of an electric motor, incorporating a brush contact surface of carbon;

FIG. 2 is a photograph showing the micro-structure of mesocarbon-microbeads;

FIG. 3 is a block diagram illustrating a method of making a carbon product;

FIG. 4 is a block diagram illustrating another method of making a carbon product;

FIG. 5 illustrates an exemplary carbon brush for an electric motor, being an example of a carbon product;

FIG. 6 illustrates an exemplary carbon bearing, being another example of a carbon product; and

FIG. 7 illustrates an exemplary carbon seal, being a further example of a carbon product.

### DETAILED DESCRIPTION OF THE PREFERRED EMBODIMENTS

For simplifying the description, a commutator of an electric motor is taken as an example of a carbon product of the instant invention.

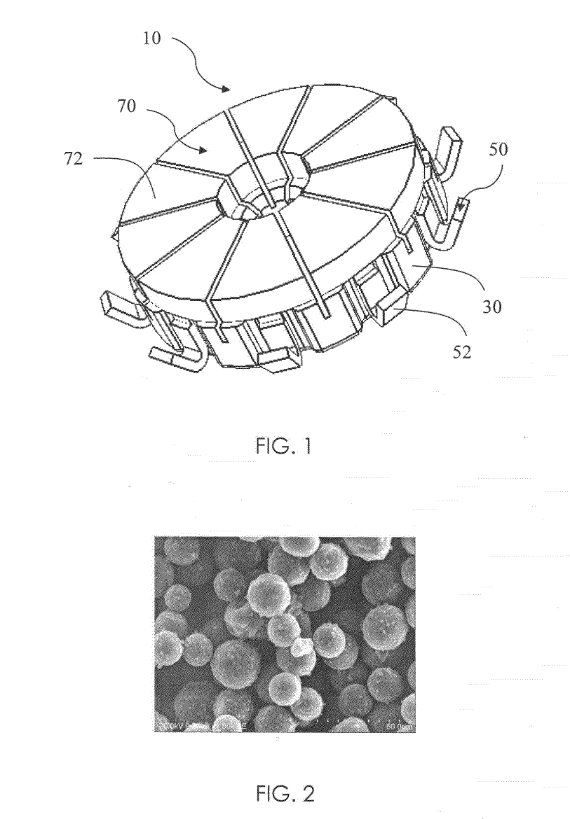

FIG. 1 illustrates a commutator 10 of an electric motor in accordance with an embodiment of the present invention. The commutator comprises a base 30 made of insulation material such as phenolic, an electrically conductive member 50 fixed to the base 30, and a contact member 70 forming a brush contact surface configured for sliding contacting with brushes of the motor. The conductive member 50 comprises a plurality of spaced bars 52 each with a tang configured for connection of a lead wire of the motor. The contact member 70 comprises a plurality of spaced segments 72 arranged in a circumferential direction of the commutator 10. Each segment 72 is electrically connected to a corresponding bar 52 of the conductive member 50. The illustrated commutator has a planar brush contact surface but the invention is also applicable to commutators with a cylindrical brush contact surface.

The contact member 70 is made of mesocarbon microbeads and graphite. Preferably, the weight percent of mesocarbon microbeads is 1 to 99% and the weight percent of graphite is 1 to 99%. More preferably, the weight percent of mesocarbon microbeads is 70-80% and the weight percent of graphite is 20-30%.

FIG. 2 is a photograph showing the micro structure of the mesocarbon microbeads. In the embodiment of the instant invention, the mesocarbon microbeads are micro sized and may be derived from pitch. When pitch is heated to approximately 200° C., it becomes a melt and the translational energy exerted on molecules by temperature is higher than the cohesion energy. As a result, a new homogeneous nucleation phase is formed and called mesophase. The growing mesophase is in spherical shape in order to minimize surface energy. When the mesophase is grown, it becomes microbeads.

The graphite may be natural graphite which is a mineral form of graphite that occurs in nature. Natural graphite is mined and processed and used in a variety of applications e.g. lubricants, seals, insulation, fillers and refractories.

Alternatively, the graphite may be artificial graphite which is a man-made form produced by heat treating non-graphitic carbon to temperatures above 2500° C. The most common artificial graphites are usually made as composites, in which ground petroleum coke is mixed into a paste with coal tar pitch and then heat treated to about 1200-1400° C. in a calcining step to carbonize the pitch and drive all volatile materials from the petroleum coke. Further heating to 2500-3000° C. causes an ordering of the carbon atoms to graphitize the mixture into true graphite. Typical use of artificial graphite is in massive electrode used in carbon-arc furnaces to melt steel, battery electrodes, and nuclear reactors.

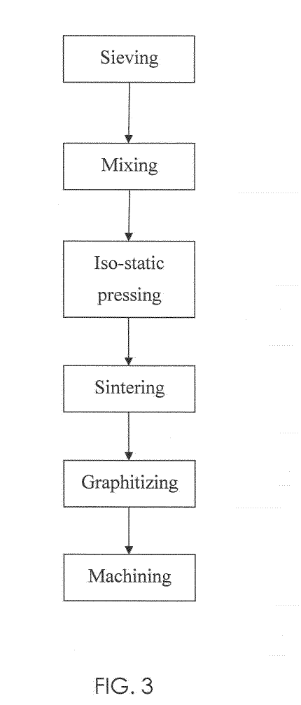

FIG. 3 illustrates a method of making a carbon product. The method comprises the following steps:

Mixing powder of mesocarbon microbeads and electrographite;

Iso-static pressing the mixed mesocarbon microbeads and graphite to form a blank;

Sintering the blank;

Graphitizing the sintered blank, the density of the graphitized blank is preferably in the range of 1.85-1.95 g/cm³, and the resistivity of the graphitized blank is preferably in the range of 500-2000 μΩ·cm; and

Machining the graphitized blank to form a final product such as an annular disc shaped contact member of a commutator.

Preferably, the method further comprises a step of sieving the mesocarbon microbeads to choose the mesocarbon microbeads with predetermined size before the mixing step. In this embodiment, the diameter of the chosen mesocarbon microbeads is less than 150 μm.

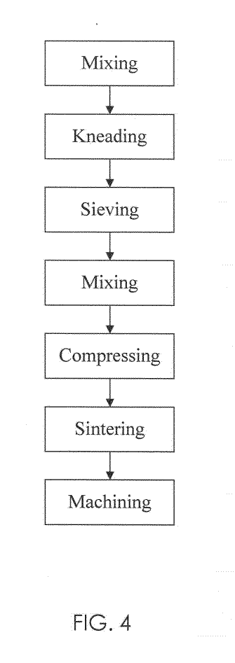

FIG. 4 illustrates another method of making a carbon product. The method comprises the following steps:

Mixing powder of mesocarbon microbeads and carbon-graphite;

Kneading the mixed mesocarbon microbeads and graphite powder;

Compressing the mixed powder to form a blank, preferably compressing the mixed powder in a mold to form a blank with predetermined shape of a final product;

Sintering the blank, the density of the sintered blank is preferably in the range of 1.6-1.8 g/cm³, and the resistivity of the sintered blank is preferably in the range of 2000-8000 μΩ·cm; and

Machining the sintered blank to form the final product, such as an annular disc shaped contact member of a commutator.

Preferably, the method further comprises a step of sieving the powder after the kneading step. Preferably, the method further comprises a step of mixing the powder after the sieving step.

In the present invention, the contact member of the commutator is made of graphite and mesocarbon microbeads. The mesocarbon microbeads are capable of self-sintering due to containing β-resin as binder, which resides on the surface of the mesocarbon microbeads. Thus, no additional binder is needed. Furthermore, the carbon product of the present invention has excellent chemical and thermal stability, electrical and thermal conductivity and improved strength due to the use of mesocarbon microbeads.

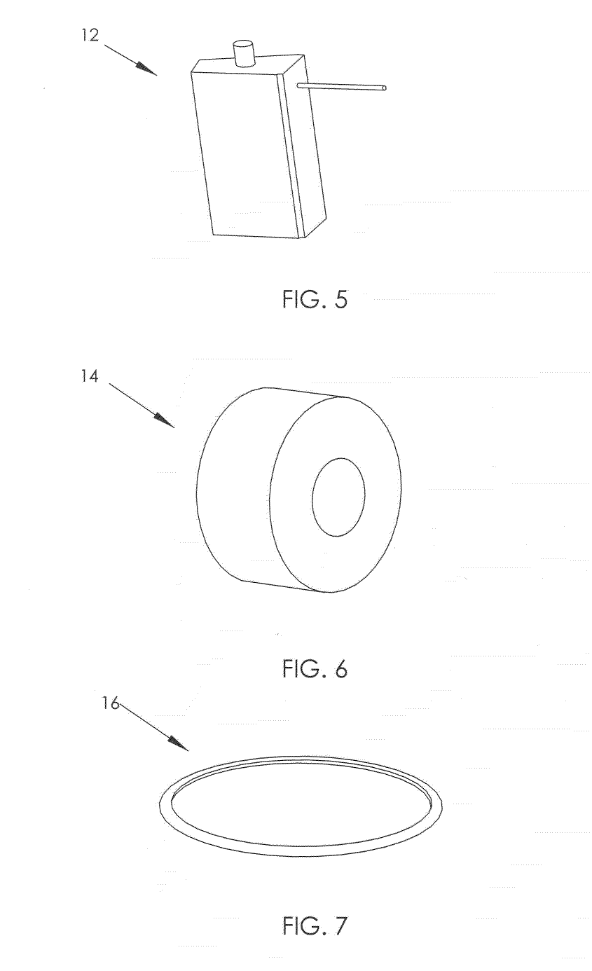

It is understood that the carbon product of the instant invention may be a carbon brush 12 as shown in FIG. 5, a carbon bearing 14 as shown in FIG. 6, or a carbon seal 16 as shown in FIG. 7. The carbon seal 16 shown in FIG. 7 is a ring seal but other forms of carbon seals are possible.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A commutator for an electric motor, comprising:
a base made of insulation material;
an electrically conductive member fixed to the base, the electrically conductive member comprising a plurality of bars each with a tang for connection of a lead wire of the motor; and
a contact member forming a brush contact surface, the contact member comprising a plurality of segments each electrically connected with a corresponding bar, the contact member comprising mesocarbon microbeads and graphite.

2. The commutator of claim 1, wherein in the contact member the weight percent of mesocarbon microbeads is 1-99% and the weight percent of graphite is 1-99%.

3. The commutator of claim 1, wherein in the contact member the weight percent of mesocarbon microbeads is 50-99% and the weight percent of graphite is 1-50%.

4. The commutator of claim 1, wherein in the contact member the weight percent of mesocarbon microbeads is 70-80% and the weight percent of graphite is 20-30%.

5. The commutator of claim 1, wherein the graphite is natural graphite.

6. The commutator of claim 1, wherein the graphite is artificial graphite.

7. The commutator of claim 1, wherein the diameter of the mesocarbon microbeads is less than 150 μm.

8. A method of making a carbon product, comprising:
mixing mesocarbon microbeads and electrographite;
iso-static pressing the mixed mesocarbon microbeads and electrographite to form a blank;
sintering the blank;
graphitizing the sintered blank; and
machining the graphitized blank to form a predetermined shape of the carbon product.

9. The method of claim 8, further comprising sieving the mesocarbon microbeads to choose the mesocarbon microbeads with size less than predetermined size before the mixing step.

10. The method of claim 8, wherein the step of sintering the blank comprises sintering the blank such that the sintered blank has a density in the range of 1.85-1.95 g/cm³ and a resistivity in the range of 500-2000 μΩ·cm.

11. A method of making a carbon product, comprising the steps of:
mixing together powdered mesocarbon microbeads and powdered carbon-graphite;
kneading the mixed mesocarbon microbead and graphite powder;
compressing the mixed powder to form a blank;
sintering the blank; and
machining the sintered blank to form the carbon product.

12. The method of claim 11, wherein the method further comprises a step of sieving the powder after the kneading step and before the compressing step.

13. The method of claim 12, wherein the method further comprises a step of mixing the powder after the sieving step and before the compressing step.

14. The method of claim 11, wherein the step of sintering the blank comprises sintering the blank such that the sintered blank has a density in the range of 1.6-1.8 g/cm³ and a resistivity in the range of 2000-8000 μΩ·cm.

15. A carbon product made of mesocarbon microbeads and graphite, wherein the weight percent of mesocarbon microbeads is 50-99% and the weight percent of graphite is 1-50%.

16. The carbon product of claim 15, wherein the weight percent of mesocarbon microbeads is 70-80% and the weight percent of graphite is 20-30%.

17. The carbon product of claim 15, wherein the carbon product is a product selected from the group consisting of: a carbon bearing; a carbon brush; a carbon seal; and a brush contact surface of a commutator.

18. The carbon product of claim 15, wherein the carbon product has a density in the range of 1.6-1.8 g/cm³ and a resistivity in the range of 2000-8000 μΩ·cm.

19. The carbon product of claim 15, wherein the carbon product has a density in the range of 1.85-1.95 g/cm³ and a resistivity in the range of 500-2000 μΩ·cm.
